(19) United States
(12) Patent Application Publication
(10) Pub. No.: US 2022/0114607 A1
(43) Pub. Date: Apr. 14, 2022

(54) METHOD, APPARATUS AND COMPUTER READABLE STORAGE MEDIUM FOR DATA PROCESSING

(71) Applicant: NEC CORPORATION, Tokyo (JP)

(72) Inventors: Wenjuan Wei, Beijing (CN); Chunchen Liu, Beijing (CN); Lvye Cui, Beijing (CN)

(73) Assignee: NEC CORPORATION, Tokyo (JP)

(21) Appl. No.: 17/069,520

(22) Filed: Oct. 13, 2020

(51) Int. Cl. G06Q 30/02; G06Q 30/00; G06N 20/00

(52) U.S. Cl. CPC G06Q 30/0204; G06N 20/00; G06Q 30/016; G06Q 30/0201

(57) ABSTRACT

Embodiments of the present disclosure relate to a method, apparatus and computer-readable storage medium for data processing. The method may comprise: obtaining feature data for characterizing a plurality of factors of a user set, the plurality of factors comprising a target factor. The method may further comprise obtaining a condition factor from the plurality of factors based on the feature data, the obtained condition factor being a cause of the target factor. The method may further comprise determining a user having the condition factor from the user set. According to the technical solution of the present disclosure, accurate user positioning and strategy formulation may be realized based on the discovery of a high-dimensional causal structure. In addition, according to the technical solution of the present disclosure, information such as the user's satisfaction degree can be simulated without performing cumbersome and inefficient questionnaire surveys.

### FIELD

Embodiments of the present disclosure mainly relate to the field of computers, and more specifically to a method, apparatus, electronic device and computer storage medium for data processing.

### BACKGROUND

With the rapid development of information technology, the scale of data has grown rapidly. Under such a background and trend, machine learning has attracted more and more attention. For example, causal discovery is widely applied in real life, for example in fields such as a supply chain, medical care and health and retail. The causal discovery here refers to discovering causal relationships among a plurality of factors from data about the plurality of factors. For example, in the retail field, results of causal discovery can be used to assist in formulating various sales strategies; in the field of medical care and health, results of causal discovery can be used to assist in formulating treatment plans for patients. How to find one or more users that meet a certain factor from multiple data, and how to determine a corresponding strategy for such users is a problem that needs to be solved urgently.

### SUMMARY

According to example embodiments of the present disclosure, there is provided a data processing solution.

In a first aspect of the present disclosure, there is provided a method for data processing. The method may comprise: obtaining feature data for characterizing a plurality of factors of a user set, the plurality of factors comprising a target factor. The method may further comprise obtaining a condition factor from the plurality of factors based on the feature data, the obtained condition factor being a cause of the target factor. The method may further comprise determining a user having the condition factor from the user set.

In a second aspect of the present disclosure, there is provided an apparatus for data processing, comprising: at least one processing unit; and at least one memory coupled to the at least one processing unit and storing instructions executed by the at least one processing unit, the instructions, when executed by the at least one processing unit, causing the apparatus to perform acts, the acts comprising: obtaining feature data for characterizing a plurality of factors of a user set, the plurality of factors comprising a target factor; obtaining a condition factor from the plurality of factors based on the feature data, the obtained condition factor being a cause of the target factor; and determining a user having the condition factor from the user set.

In a third aspect of the present disclosure, there is provided a computer-readable storage medium having machine-executable instructions stored thereon, the machine-executable instructions, when executed by an apparatus, causing the apparatus to perform the method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features of the present disclosure will be made apparent by the following depictions.

### BRIEF DESCRIPTION OF THE DRAWINGS

Through the following detailed description with reference to the accompanying drawings, the above and other objectives, features, and advantages of example embodiments of the present disclosure will become more apparent. In example embodiments of the present disclosure, the same reference symbols usually refer to the same components.

FIG. 1 illustrates a block diagram of an example system for data processing according to an embodiment of the present disclosure;

FIG. 2 illustrates a schematic diagram for determining the causal relationship among a plurality of factors according to an embodiment of the present disclosure;

FIG. 3 illustrates a flowchart of an exemplary data processing process according to an embodiment of the present disclosure;

FIG. 4 illustrates a flowchart of a process of determining a condition factor according to an embodiment of the present disclosure;

FIG. 5 illustrates a flowchart of an example process of determining a strategy according to an embodiment of the present disclosure;

FIG. 6 illustrates a flowchart of another example process of determining a strategy according to an embodiment of the present disclosure; and

FIG. 7 illustrates a schematic block diagram of an example device that may be used to implement embodiments of the present disclosure.

### DETAILED DESCRIPTION OF EMBODIMENTS

Preferred embodiments of the present disclosure will be described in greater detail with reference to the drawings. Although the drawings present the preferred embodiments of the present disclosure, it should be understood that the present disclosure can be implemented in various ways and should not be limited by the embodiments disclosed herein. Rather, those embodiments are provided for thorough and complete understanding of the present disclosure, and completely conveying the scope of the present disclosure to those skilled in the art.

In the depictions of embodiments of the present disclosure, the term “includes” and its variants are to be read as open-ended terms that mean “includes, but is not limited to.” The term “based on” is to be read as “based at least in part on.” The term “one example implementation” and “an example implementation” are to be read as “at least one example implementation.” Terms “a first”, “a second” and others may denote different or identical objects. The following text may also contain other explicit or implicit definitions.

In the embodiments of the present disclosure, the term “causal structure” generally refers to a structure that describes causal relationships between factors in the system, and is also referred to as a “causal relationship sequence” herein. The term “factor” is also referred to as “variable”. The term “feature data” refers to a set of data about a plurality of factors that can be viewed directly or calculated through characterization.

In the field of service, in order to determine which factors will affect the user's satisfaction degree for the service or product provider, it is possible to collect one or more types of data in the user's consumption behavior data for the service or product, survey data for the satisfaction degree, and the service or product provider's strategy data for the service or product. Each type of the collected data is also referred to as feature data of one factor (or variable). One or more factors that affect the satisfaction degree may be determined by discovering the causal relationship among these factors. Further, the user's satisfaction degree for the service or product provider can be improved by formulating a corresponding strategy for the one or more factors. For example, as for the satisfaction degree for a telecommunication operator, it is possible to collect a large number of users' consumption behavior data (such as user attributes, monthly consumption of Internet traffic, a ratio of free traffic, a total fee for the monthly consumption of Internet traffic, etc.), satisfaction degree survey data and feature data of factors such as evaluation and complaint information. One or more factors that affect the satisfaction degree can be determined by discovering the causal relationship among these factors. Further, the user's satisfaction degree for the telecommunication operator may be improved by formulating a corresponding strategy for the one or more factors.

In the field of health care, in order to determine the factors that affect the patient's disease or a rate of change of a certain physiological index, a series of physiological indexes (i.e., observations of a series of factors) of a large number of patients may be collected, taking blood pressure as an example, such as heart rate, cardiac output, allergy index, total peripheral vascular resistance, catecholamine release, blood pressure, etc. Physiological indices (i.e., factors) that affect the patient's disease or the rate of change of a physiological index (such as blood pressure) can be determined by discovering the causal relationship among these physiological indices. Furthermore, the physiological index (such as blood pressure) of the patient may be kept stable by influencing the physiological index or formulating a corresponding strategy for the physiological index.

In the field of merchandise sales, in order to determine factors that affect the sales of a target merchandise (for example, umbrellas), external factor data (such as weather, season, temperature, date, store size, etc.), sales data of the merchandise (e.g., the sales volume of the merchandise, the price of the merchandise, etc.), and sales data of one or more associated merchandises (for example, ice cream) may be collected. Each type of data collected serve as feature data of a type of factor. One or more factors that affect the sales of the target merchandise may be determined by discovering the causal relationship among these factors. Furthermore, the sales of the target merchandise may be increased by formulating a corresponding strategy for the one or more factors.

In the field of software development, in order to determine factors that affect the failure rate and/or software development cycle, information about various factors of software development may be collected, including but not limited to overall information about software development (such as development cycle, resources input into the development, etc.) and information about each stage of software development. The information about each stage of software development may include, for example, information about an architecture stage (such as software architecture method, the number of software architecture levels, etc.), information about a coding stage (such as code length, number of functions, programming language, number of modules, etc.), information about a testing stage (such as a correct rate or failure rate of unit testing, a correct rate or failure rate of black box testing, a correct rate or failure rate of white box testing, etc.), and information about a running stage after software release (such as a correct rate or failure rate of the running stage). Each type of data collected serves as the feature data of a factor. One or more factors that affect the software development cycle and/or failure rate can be determined by discovering the causal relationship among these factors. Furthermore, the software development cycle and/or failure rate may be reduced by formulating a corresponding strategy for the one or more factors.

Some traditional solutions mainly relate to collecting a small portion of users' feedback results in a user-orientated data collection manner, and then formulating a corresponding strategy based on the feedback results. However, according to the conventional solutions, the users are sought for only according to simple, predetermined rules, and furthermore, the strategy determined for such type of users is not specific so that the strategy, after being applied to the user, cannot achieve a desirable effect, even achieves a reverse effect.

According to an embodiment of the present disclosure, a solution for data processing is proposed. This solution can realize accurate user positioning and strategy formulation based on the discovery of a high-dimensional causal structure, thereby being able to solve the above-mentioned problems and/or other potential problems. Hereinafter, embodiments of the present disclosure will be described in detail in conjunction with the above example scenarios. It should be appreciated that this is for illustrative purposes only and is not intended to limit the scope of the present invention in any way.

FIG. 1 illustrates a block diagram of an example system 100 for data processing according to an embodiment of the present disclosure. It should be appreciated that the system 100 shown in FIG. 1 is only an example in which the embodiment of the present disclosure may be implemented, and is not intended to limit the scope of the present disclosure. The embodiment of the present disclosure is also applicable to other systems or architectures.

As shown in FIG. 1, the system 100 may include a computing device 120. The computing device 120 may receive the feature data 110 for characterizing a plurality of factors of a user set, and determine a user 130 who meets a specific condition factor therefrom. As an example, after a factor that is closely related to all users or a plurality of users is determined from the above plurality of factors as a target factor, one or more condition factors that cause the target factor (or as the cause of the target factor) may be determined by the computing device. Then, the user 130 who meets the one or more condition factors may be determined from the user set. The user 130 may be a single, individual user, or may be a user subset in the user set. In some embodiments, the system 100 may further include a data collection device (not shown in FIG. 1) for collecting required feature data 110, especially collecting, by a computer, network data related to evaluations and complaints. The data collection device may collect feature data 110 of a plurality of factors in real time, regularly or irregularly. In some embodiments, the data collection device may include one or more collection units for collecting feature data of different types of factors.

Optionally, in some embodiments, the computing device 120 may further include a condition factor determining means for obtaining a specific condition factor that serves as the cause of the target factor from the plurality of factors according to the feature data 110 and the target factor. In some embodiments, the computing device 120 may further determine a strategy 140 based on the feature data 110, and the strategy 140 may change the feature data that characterizes the target factor. After the user 130 and the strategy 140 are determined, the strategy 140 may be applied to the user 130.

Taking the above scenario of user's satisfaction degree for a telecommunication operator as an example, for example, the target factor is “user's satisfaction degree”, and the set of factors may include one type or more types of factors in factors related to user attributes (for example, user level, user gender, user age, etc.)), factors related to the service provided by the operator to the user (for example, package name, monthly package value, monthly consumption value, etc.), factors related to user behavior (for example, incoming call/outgoing call duration per month, monthly consumption of Internet traffic, a ratio of free traffic, a total value of monthly consumption of Internet traffic, a number of logins onto related website/APP, historical information about the browse on related website/APP web, etc.), and factors related to user feedback (for example, the number of complaints, content of complaints, user's satisfaction degree). The above-mentioned condition factor determining means may obtain the condition factor that serves as the cause of the target factor, for example by determining the causal relationship among factors such as user attributes, monthly consumption of Internet traffic, a ratio of free traffic, a total value of monthly consumption of Internet traffic and the user's satisfaction degree. For example, which condition factors cause the target factor “user's satisfaction degree” to be low.

Taking the above scenario about patient's blood pressure as an example, for example, the target factor is “blood pressure”, and the set of factors may include heart rate, cardiac output, allergy index, total peripheral vascular resistance, catecholamine release, blood pressure, etc. The above-mentioned condition factor determining means may obtain the condition factor that serves as the cause of the target factor, for example, by determining the causal relationship among factors such as heart rate, cardiac output, allergy index, total peripheral vascular resistance, catecholamine release and blood pressure. For example, what factors cause the target factor “blood pressure” to be high or low.

Taking the above merchandise sales scenario as an example, for example, the target factor is “target merchandise sales”, the set of factors may include one type or more types of the following factors: external factor (such as weather, season, temperature, date, store size, etc.), factors (such as the sales volume of the target merchandise, the price of the target merchandise, etc.) related to sales behaviors of the target merchandise (e.g., umbrella), and factors related to sales behaviors of one or more associated merchandises (for example, ice cream) (such as the sales volume of the associated merchandise, the price of the associated merchandise) and sales strategy factors (such as the number of promotions, frequency, etc.) for the target merchandise. The above-mentioned condition factor determining means for example may obtain the condition factor that serves as the cause of the target factor by determining the causal relationship among factors such as weather, season, temperature, date, store size, target merchandise sales, target merchandise price, sales of associated merchandises, and prices of the associated merchandises. For example, what factors cause the target factor “sales of target merchandises” to be low.

Taking the above-mentioned software development scenario as an example, for example, the target factor is “software development cycle” or “a failure rate in a software running phase”, and the set of factors may include one or more types of the following factors: overall factors of software development (such as development cycle, resources input into the development, etc.) and factors of each stage of software development. The factors of each stage of software development may include, for example, factors of an architecture stage (such as software architecture method, the number of software architecture levels, etc.), factors of a coding stage (such as code length, number of functions, programming language, number of modules, etc.), factors of a testing stage (such as a correct rate or failure rate of unit testing, a correct rate or failure rate of black box testing, a correct rate or failure rate of white box testing, etc.), and factors of a running stage after software release (such as a correct rate or failure rate of the running stage). The above condition factor determining means for example may obtain the condition factor that serves as the cause of the target factor by determining the casual relationship among factor such as the development cycle, resources input into the development, software architecture method, the number of software architecture levels, code length, number of functions, programming language, number of modules, a correct rate or failure rate of unit testing, a correct rate or failure rate of black box testing, a correct rate or failure rate of white box testing, a correct rate of the running stage and a failure rate of the running stage. Furthermore, what factors cause the target factor “development cycle” to be long, and what factors cause the target factor “the failure rate of the running stage” to be high.

It should be understood that these means and/or units in the means included in the system 100 are only exemplary, and are not intended to limit the scope of the present disclosure. It should be understood that the system 100 may further include additional means and/or units not shown. For example, in some embodiments, the computing device 120 of the system 100 may further include a causal relationship presenting means (not shown) for presenting the causal relationship sequence of the aforementioned plurality of factors.

In some embodiments, when the cause of the target factor includes a plurality of factors, the causal relationship presenting means may further present corresponding importance degrees of the plurality of factors, for example, present the corresponding importance degrees of the plurality of factors in a manner of representing values of different importance degrees (such as influence factors). The embodiments of the present disclosure are not limited in this respect.

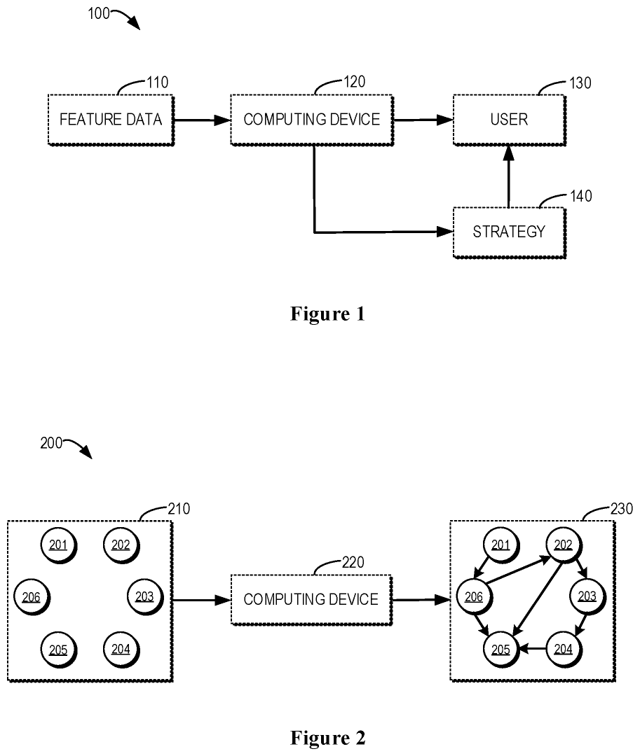

FIG. 2 illustrates a schematic diagram for determining the causal relationship among a plurality of factors according to an embodiment of the present disclosure. For the purpose of simplification and ease of illustration, it is assumed in FIG. 2 that the feature data 210 involves six factors 201, 202, 203, 204, 205 and 206. It should be understood that the number of factors involved may be much greater than six.

As shown in FIG. 2, the feature data 210 includes a plurality of data about factors 201, 202, 203, 204, 205 and 206. In an initial case, as shown in the feature data 210 in FIG. 2, there may be a causal relationship between any two factors.

In some embodiments, the feature data 210 may be input to the computing device 220 to determine the possible causal relationship among the plurality of factors 201, 202, 203, 204, 205 and 206. It should be understood that the computing device 220 may use any known or future-developed causal analysis processing manner to determine possible causal relationship among the plurality of factors 201, 202, 203, 204, 205 and 206. As an example, the computing device 220 may include a machine learning model such as the conditional factor determination means. The machine learning model is trained to determine the causal relationship among the plurality of factors in training data sets based on the training data sets of a plurality of users, and then determine one or more condition factors that serve as the target factor. Alternatively or additionally, the machine learning model may be a Convolutional Neural Network (CNN).

As shown in FIG. 2, a causal relationship structure 230 output by the computing device 220, for example, indicates that factor 201 is the cause of factor 206, factor 206 is the cause of factor 202 and factor 205, factor 202 is the cause of factors 203 and 205, factor 203 is the cause of factor 204, and factor 204 is the cause of factor 205. Assuming that the target factor is factor 205, it can be determined that the reasons for the target factor 205 are factors 202, 204 and 206.

Taking the foregoing scenario regarding a user's satisfaction degree for a telecommunication operator as an example, the target factor 205 is the user's “satisfaction degree for the tariff”, the condition factor 206 is a factor related to voice consumption, and the condition factor 202 is a factor related to traffic consumption. As shown in FIG. 2, the factor 206 related to the voice consumption may be a direct cause of the satisfaction degree for the tariff 205, or it is also possible to indirectly act on the satisfaction degree for the tariff 205 through a condition factor of the factor 202 related to the traffic consumption. Hence, at least a value corresponding to the factor related to voice consumption may be determined as the condition factor. In other words, the value corresponding to the factor related to voice consumption affects the user's satisfaction degree for the tariff. Alternatively or additionally, it can be found through further analysis that when the value corresponding to the factor related to the voice consumption is greater than a specific threshold, the user's satisfaction degree for the tariff is lower, so that a user with the value corresponding to the factor related to the voice consumption being greater than the threshold in the user set may be determined as the user 130.

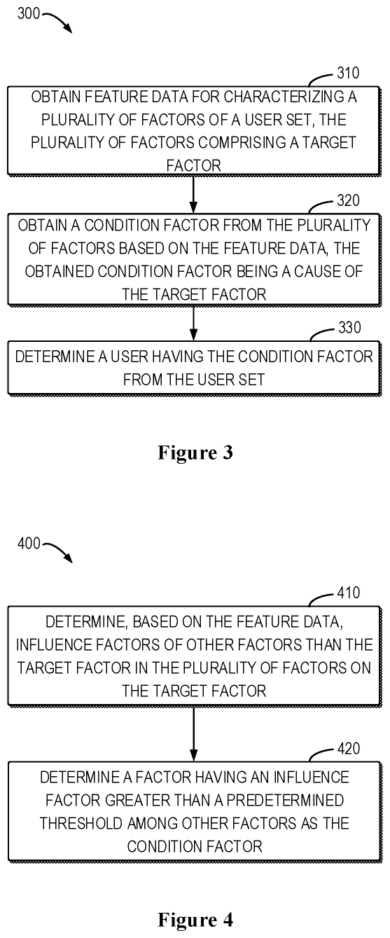

FIG. 3 illustrates a flowchart of an exemplary data processing process 300 according to an embodiment of the present disclosure. For example, the process 300 may be performed by the computing device 120 as shown in FIG. 1. It should be understood that the process 300 may also include additional actions not shown and/or some actions shown may be omitted. The scope of the present disclosure is not limited in this respect.

At 310, the computing device 120 may be configured to obtain the feature data 110 for characterizing a plurality of factors of the user set. It should be understood that the plurality of factors include a target factor. As described above, each user in the user set has feature data about the plurality of factors, particularly the feature data which is about the target factor and of interest. As an example, the target factor may be user's satisfaction degree in the telecommunication operator scenario, the blood pressure in the medical care scenario, target merchandise sales in the merchandise sales scenario, or software development cycle in the software development scenario.

In some embodiments, a data preprocessing process may be performed, for example, first obtaining evaluation data of users in the user set evaluating these factors. As an example, text data of a user's evaluation of a certain function of the business on a related APP or webpage may be obtained as the evaluation data. Alternatively or additionally, the user's voice complaint may be textualized, and the text data related to the complaint may be processed into the evaluation data. In addition, text data or a score entered by the user in the survey data may also be taken as the evaluation data. After obtaining the evaluation data, the data preprocessing process may further include determining the feature data based on the evaluation data. As an example, the obtained evaluation data, especially text data, may be processed to obtain the feature data. For example, a semantic learning model may be used to score text data in the user's evaluation data. In addition, the data preprocessing process may further include data preprocessing for other types of factors to better facilitate causal analysis of the data. The data preprocessing may further include, but is not limited to, numericalization of the factors, deletion of erroneous data, and filling of missing data.

In some embodiments, a feature engineering process may be performed based on the target factor, for example, first obtain historical information of the user set about these factors in a predetermined time period, and then determine the feature data based on the historical information. As an example, a value of one factor of these factors in a certain time period may be obtained from the historical information as the feature data, for example, the value corresponding to the factor related to the voice consumption. As another example, values of two or more of these factors in a certain time period may be obtained from the historical information, and the feature data may be obtained by calculating the obtained values. For example, it is possible to obtain a proportion of a user's voice consumption by dividing the value corresponding to the factor related to voice consumption by a total consumption value, obtain a proportion of the number of actively-initiated services of a user by dividing the number of actively-initiated services by a total number of services, and obtain a user's voice margin ratio by dividing a duration of the caller's call by the voice charges, and so on.

As a preferred example, a first value of one factor of these factors in a first time period and a second value in a second time period may further be obtained from the historical information, for example, the first time period may be equal to or approximately equal to the second time period. Furthermore, a data fluctuation rate of the user set regarding said one factor may be determined based on the first value and the second value. Preferably, the data fluctuation rate may be a ratio of a difference between the first value and the second value to the first value or the second value. For example, it is possible to subtract a total consumption value of another month adjacent to a certain month from a total consumption value of said certain month, and divide the difference by one of the two total consumption values to obtain the fluctuation rate of the total consumption value. In addition, alternatively or additionally, the feature data may also be determined by performing operations such as averaging and variance on the values in a plurality of time periods. In this way, the user's certain behavioral feature may be acquired by mining features with specific physical meanings, and the acquired feature data may better reflect the user's behaviors.

At 320, the computing device 120 may be configured to obtain a conditional factor from these factors based on the feature data, and the obtained condition factors is the cause of the target factor. As described above, the computing device 220 may use any known or future-developed processing manner to determine the possible causal relationship between these factors, and find the condition factor that serves as the cause of the target factor. For ease of presentation, the process of determining the condition factor will be described in detail below with reference to FIG. 4.

FIG. 4 illustrates a flowchart of a process 400 of determining a condition factor according to an embodiment of the present disclosure. For example, the process 400 may be performed by the computing device 120 as shown in FIG. 1. It should be understood that the process 400 may also include additional actions not shown and/or some actions shown may be omitted. The scope of the present disclosure is not limited in this respect.

At 410, the computing device 120 may be configured to determine, based on the feature data, influence factors of other factors than the target factor in these factors on the target factor. As an example, in the above-mentioned telecommunication operator scenario, the computing device 220 may use any known or future-developed processing manner to determine the influence factors of other factors on the satisfaction degree as the target factor. For example, the influence factors of the factors on satisfaction degree as the target factor are: a, b, c, d . . . .

At 420, the computing device 120 may be configured to determine a factor having an influence factor greater than a predetermined threshold among other factors as a condition factor. Still referring to the above example, the predetermined threshold may be set to T. If “a” and “b” are greater than T, the factors of a and b may be determined as condition factors. In this way, the machine learning model may be used to find, from the plurality of factors, the condition factors leading to the target factor.

Returning to FIG. 3, at 330, the computing device 120 may be configured to determine the user 130 having the condition factor from the user set. As an example, the computing device 120 may be configured to determine a user in the user set whose condition factor meets a specific threshold as the user 130. Alternatively or additionally, the computing device 120 may also be configured to determine as the user 130 a user in the user set whose condition factor has a specific value. For example, in the above telecommunication operator scenario, it may be determined through the above process that the cause of the user's satisfaction degree below the predetermined threshold is that the value corresponding to the factor related to the voice consumption is high, and a user in the user set that the value corresponding to the factor related to the voice consumption is higher than the predetermined threshold may be determined as the user 130. Through the above processing, it is possible to determine the users who meet the specific condition factors in the user set based on the feature data of the user set including a plurality of users, thereby realizing people group positioning of partial or all users with a low user satisfaction degree, a high blood pressure, a small sales volume of the target merchandise and a long software development cycle. It should be appreciated that the people group positioning of the present disclosure is not to position a people group with a low satisfaction degree, but position the people group that meets the condition factor by determining the condition factor causing the low satisfaction degree. Therefore, the people group positioning manner of the present disclosure is more detailed, accurate, and has strong robustness.

In some embodiments, the process 300 may further include the computing device 120 determining a strategy 140 based on the acquired feature data, and the strategy 140 is used to change the feature data that characterizes the target factor. After the user 130 and the strategy 140 are determined, the strategy 140 may be provided to the user 130. Through the above processing, a specific user or user group may be determined based on the feature data of a user set containing a plurality of users and a corresponding strategy may be formulated, thereby providing a corresponding strategy to partial or all users for example with a low user satisfaction degree, a high blood pressure, a small sales volume of the target merchandise and a long software development cycle, thereby achieving effects such as enhancing the user's satisfaction degree, improving the blood pressure condition, increasing the sales of the merchandise and shortening the software development cycle.

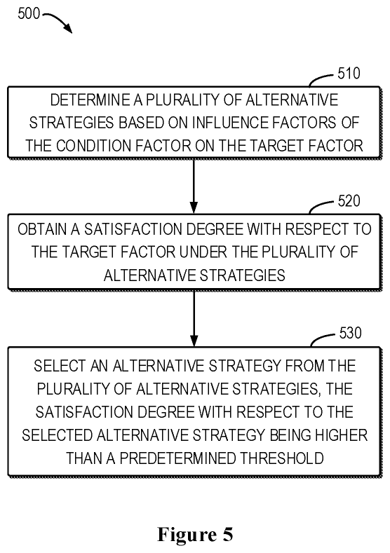

FIG. 5 illustrates a flowchart of an example process 500 of determining a strategy 140 according to an embodiment of the present disclosure. For example, the process 500 may be performed by the computing device 120 as shown in FIG. 1. It should be appreciated that the process 500 may also include additional actions not shown and/or certain actions shown may be omitted. The scope of the present disclosure is not limited in this respect.

At 510, the computing device 120 may be configured to determine one or more alternative strategies based on the influence factor of the condition factor on the target factor. It should be understood that the computing device 120 may be manufactured to include a machine learning model with a simulation function. The machine learning model is trained to determine the influence factors of each condition factor on the target factor based on the feature data of the user set, and then determine the strategy with respect to all condition factors or partial condition factors with higher influence factors.

As an example, in the above telecommunication operator scenario, the machine learning model may determine the influence factors of each factor on the satisfaction degree as the target factor according to the feature data, the influence factors being a, b, c, d, respectively, Furthermore, the machine learning model may respectively formulate a corresponding strategy for factors with higher influence factors a and b. These strategies are determined as alternative strategies.

As another example, in the above-mentioned medical care scenario, the machine learning model may determine the influence factors of conditional factors such as heart rate, cardiac output, allergy index, total peripheral vascular resistance, etc., on blood pressure as the target factor according to the feature data: e, f, g, h . . . Furthermore, the machine learning model may respectively formulate corresponding strategies for the heart rate and cardiac output with higher impact factors. These strategies are determined as alternative strategies.

As a further example, in the above-mentioned merchandise sales scenario, the machine learning model may determine, according to the feature data, the influence factors of condition factors such as external factors, factors related to the sales behavior of the target merchandise and sales strategy factors for the target merchandise on the sales of the target merchandise as the target factor, the influence factors being j, k, 1, . . . , respectively. Furthermore, the machine learning model may respectively formulate corresponding strategies with respect to external factors with high influence factors and factors related to the sales behaviors of the target merchandise. These strategies are determined as alternative strategies.

For the foregoing telecommunication operator scenario, at 520, the computing device 120 may be configured to obtain the satisfaction degree with respect to the target factor under a plurality of alternative strategies. It should be understood that the computing device 120 may be manufactured to include a machine learning model with a simulation function. The machine learning model is trained to determine the satisfaction degree for each alternative strategy based on the feature data of the user set and the alternative strategies determined above. Through this process, simulated satisfaction degree information may be obtained without collecting specific satisfaction degree information of the plurality of users for corresponding strategies.

For the foregoing telecommunication operator scenario, at 530, the computing device 120 may be configured to select one alternative strategy from the plurality of alternative strategies, and the satisfaction degree of the selected alternative strategy is higher than a predetermined threshold. Thus, the selected alternative strategy 140 may be applied to the corresponding user 130. In this process, a strategy with a high satisfaction degree may be selected through the simulation process of the machine learning model, without relying on results of an inefficient questionnaire survey.

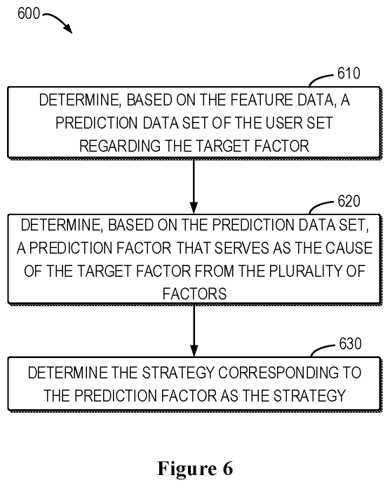

FIG. 6 illustrates a flowchart of another example process 600 of determining a strategy according to an embodiment of the present disclosure. For example, the process 600 may be performed by the computing device 120 as shown in FIG. 1. It should be understood that the process 600 may also include additional actions not shown and/or certain actions shown may be omitted. The scope of the present disclosure is not limited in this respect.

At 610, the computing device 120 may be configured to determine a prediction data set for the target factor of the user set based on the feature data. It should be understood that the computing device 120 may be manufactured to include a machine learning model with a simulation function. The machine learning model is trained to determine the prediction data set of each user in the user set for the target factor based on the feature data of the user set, such as the satisfaction degree obtained by simulation. In this text, “prediction” generally refers to a “simulation” operation of the computing device 120 or the trained machine learning model therein, for example, each user's satisfaction degree may be predicted based on feature data such as the value corresponding to the factor related to voice consumption, or other user attributes.

As an example, in the foregoing telecommunication operator scenario, the machine learning model may determine each user's satisfaction degree score as a prediction data set, and determine users whose satisfaction degree scores are lower than a predetermined threshold as unsatisfied users. Through this process, simulated satisfaction degree information may be obtained, and potential unsatisfied users may be determined without collecting users' specific satisfaction degree information for corresponding strategies.

At 620, the computing device 120 may be configured to determine a prediction factor that serves as a cause of the target factor from a plurality of factors based on the prediction data set. As an example, in the above telecommunication operator scenario, the machine learning model may determine the condition factors that cause each user's low satisfaction degree score based on the above satisfaction degree information as the prediction data set. Furthermore, the machine learning model may group the above-mentioned unsatisfied users according to the determined predictive factors. For example, unsatisfied users may be grouped into: users with high values corresponding to factors related to voice consumption, users with a large proportion of the number of actively-initiated services, and so on. Alternatively or additionally, the machine learning model may determine a condition factor causing a low satisfaction degree based on the aforementioned satisfaction degree information.

At 630, the computing device 120 may be configured to determine the strategy corresponding to the prediction factor as the strategy. As an example, in the above telecommunication operator scenario, the machine learning model may formulate a corresponding strategy for each group, for example, provide a strategy for reducing the value of voice consumption for the user group with high values corresponding to factors related to the voice consumption, and provide a strategy for presenting a service time length as a gift for the user group with a large proportion of the number of actively-initiated services.

In this way, according to the embodiments of the present disclosure, information such as the user's satisfaction degree can be predicted without performing cumbersome and inefficient questionnaire surveys.

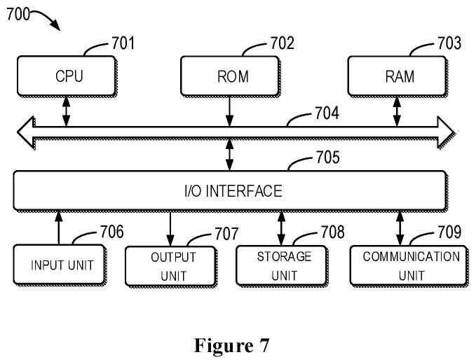

FIG. 7 illustrates a schematic block diagram of an example device 700 that may be used to implement embodiments of the present disclosure. For example, the computing device 120 shown in FIG. 1 and the computing device 220 shown in FIG. 2 may both be performed by the device 700. As illustrated, the device 700 includes a central processing unit (CPU) 701 which may perform various appropriate actions and processing according to the computer program instructions stored in a read-only memory (ROM) 702 or the computer program instructions loaded from a storage unit 708 into a random access memory (RAM) 703. The RAM 703 may also store all kinds of programs and data required by operating the storage device 700. CPU 701, ROM 702 and RAM 703 are connected to each other via a bus 704. An input/output (I/O) interface 705 is also connected to the bus 704.

A plurality of components in the device 700 are connected to the I/O interface 705, including: an input unit 706, such as keyboard, mouse and the like; an output unit 707, such as various types of display, loudspeakers and the like; a storage unit 708, such as magnetic disk, optical disk and the like; and a communication unit 709, such as network card, modem, wireless communication transceiver and the like. The communication unit 709 allows the device 700 to exchange information/data with other devices through computer networks such as Internet and/or various telecommunication networks.

The processing unit 701 may be implemented by one or more processing circuits. The processing unit 70 may be configured to execute each procedure and processing described above, such as methods 300, 400, 500 and/or 600. As an example, in some embodiments, the methods, 300, 400, 500 and/or 600 may be implemented as computer software programs, which are tangibly included in a machine-readable medium, such as storage unit 708. In some embodiments, the computer program may be partially or completely loaded and/or installed to the device 700 via ROM 702 and/or the communication unit 709. When the computer program is loaded to RAM 703 and executed by CPU 701, one or more steps of the above described methods 300, 400, 500 and/or 600 may be implemented.

The present disclosure may be a system, a method and/or a computer program product. The computer program product can include a computer-readable storage medium loaded with computer-readable program instructions thereon for executing various aspects of the present disclosure.

The computer readable storage medium may be a tangible device capable of holding and storing instructions used by an instruction execution device. The computer readable storage medium may be, but is not limited to, for example, electronic storage devices, magnetic storage devices, optical storage devices, electromagnetic storage devices, semiconductor storage devices, or any random appropriate combination thereof. More specific examples (non-exhaustive list) of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as a punched card storing instructions or an emboss within a groove, and any random suitable combination thereof. A computer readable storage medium used herein is not interpreted as a transitory signals per se, such as radio waves or other freely propagated electromagnetic waves, electromagnetic waves propagated through a waveguide or other transmission medium (e.g., optical pulses passing through fiber-optic cables), or electrical signals transmitted through electric wires.

The computer readable program instructions described herein may be downloaded from a computer readable storage medium to various computing/processing devices, or to external computers or external storage devices via a network, for example, the Internet, a local area network, a wide area network and/or a wireless network. The network may include copper transmission cables, optical fiber transmission, wireless transmission, routers, firewalls, switches, gateway computers and/or edge servers. The network adapter or network interface in each computing/processing device receives computer readable program instructions from the network and forwards the computer readable program instructions for storage in a computer readable storage medium of each computing/processing device.

Computer readable program instructions for executing the operations of the present disclosure may be assembly instructions, instructions of instruction set architecture (ISA), machine instructions, machine dependent instructions, microcode, firmware instructions, state setting data, or either source code or destination code written by any combination of one or more programming languages including object oriented programming languages, such as Smalltalk, C++ or the like, and conventional procedural programming languages, such as the “C” programming language or similar programming languages. The computer-readable program instructions may be completely or partially executed on the user computer, or executed as an independent software package, or executed partially on the user computer and partially on the remote computer, or completely executed on the remote computer or the server. In the case where a remote computer is involved, the remote computer may be connected to the user computer by any type of networks, including local area network (LAN) or wide area network (WAN), or connected to an external computer (such as via Internet provided by the Internet service provider). In some embodiments, the electronic circuit is customized by using the state information of the computer-readable program instructions. The electronic circuit may be a programmable logic circuit, a field programmable gate array (FPGA) or a programmable logic array (PLA) for example. The electronic circuit may execute computer-readable program instructions to implement various aspects of the present disclosure.

Various aspects of the present disclosure are described in reference with the flow chart and/or block diagrams of method, apparatus (systems), and computer program product according to embodiments of the present disclosure. It will be understood that each block in the flow chart and/or block diagrams, and any combinations of various blocks thereof may be implemented by computer readable program instructions.

The computer-readable program instructions may be provided to the processing unit of a general purpose computer, a dedicated computer or other programmable data processing devices to generate a machine, causing the instructions, when executed by the processing unit of the computer or other programmable data processing devices, to generate a device for implementing the functions/actions specified in one or more blocks of the flow chart and/or block diagram. The computer-readable program instructions may also be stored in the computer-readable storage medium. These instructions enable the computer, the programmable data processing device and/or other devices to operate in a particular way, such that the computer-readable medium storing instructions may comprise a manufactured article that includes instructions for implementing various aspects of the functions/actions specified in one or more blocks of the flow chart and/or block diagram.

The computer readable program instructions may also be loaded into computers, other programmable data processing devices, or other devices, so as to execute a series of operational steps on the computer, other programmable data processing devices or other devices to generate a computer implemented process. Therefore, the instructions executed on the computer, other programmable data processing devices, or other device may realize the functions/actions specified in one or more blocks of the flow chart and/or block diagram.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for data processing, comprising:
obtaining feature data for characterizing a plurality of factors of a user set, the plurality of factors comprising a target factor;
obtaining a condition factor from the plurality of factors based on the feature data, the obtained condition factor being a cause of the target factor; and
determining a user having the condition factor from the user set.

2. The method according to claim 1, further comprising:
determining a strategy for changing feature data characterizing the target factor based on the feature data; and
providing the strategy to the user.

3. The method according to claim 2, wherein determining the strategy based on the feature data comprises:
determining a plurality of alternative strategies based on influence factors of the condition factor on the target factor;
obtaining satisfaction degree with respect to the target factor under the plurality of alternative strategies; and
selecting an alternative strategy from the plurality of alternative strategies, the satisfaction degree with respect to the selected alternative strategy being higher than a predetermined threshold.

4. The method according to claim 2, wherein determining the strategy based on the feature data comprises:
determining, based on the feature data, a prediction data set of the user set regarding the target factor;
determining, based on the prediction data set, a prediction factor that serves as the cause of the target factor from the plurality of factors; and
determining the strategy corresponding to the prediction factor as the strategy.

5. The method according to claim 1, wherein obtaining the feature data comprises:
obtaining evaluation data of users in the user set for evaluating the plurality of factors; and
determining the feature data based on the evaluation data.

6. The method according to claim 1, wherein obtaining the feature data comprises:
obtaining historical information about the plurality of factors of the user set within a predetermined time period; and
determining the feature data based on the historical information.

7. The method according to claim 6, wherein determining the data based on the historical information comprises:
obtaining, from the historical information, a first value of one factor of the plurality of factors in a first time period and a second value in a second time period;
based on the first value and the second value, determining a data fluctuation rate of the user set regarding the one factor.

8. The method according to claim 7, wherein the data fluctuation rate is a ratio of a difference between the first value and the second value to the first value or the second value.

9. The method according to claim 1, wherein obtaining the condition factor from the plurality of factors based on the feature data comprises:
determining, based on the feature data, influence factors of other factors than the target factor in the plurality of factors on the target factor; and
determining a factor having an influence factor greater than a predetermined threshold among other factors as the condition factor.

10. An apparatus for data processing, comprising:
at least one processing unit; and
at least one memory coupled to the at least one processing unit and storing instructions executed by the at least one processing unit, the instructions, when executed by the at least one processing unit, causing the apparatus to perform acts, the acts comprising:
obtaining feature data for characterizing a plurality of factors of a user set, the plurality of factors comprising a target factor;
obtaining a condition factor from the plurality of factors based on the feature data, the obtained condition factor being a cause of the target factor; and
determining a user having the condition factor from the user set.

11. The apparatus according to claim 10, wherein the acts further comprise:
determining a strategy for changing feature data characterizing the target factor based on the feature data; and
providing the strategy to the user.

12. The apparatus according to claim 11, wherein determining the strategy based on the feature data comprises:
determining a plurality of alternative strategies based on influence factors of the condition factor on the target factor;
obtaining satisfaction degree with respect to the target factor under the plurality of alternative strategies; and
selecting an alternative strategy from the plurality of alternative strategies, the satisfaction degree with respect to the selected alternative strategy being higher than a predetermined threshold.

13. The apparatus according to claim 11, wherein determining the strategy based on the feature data comprises:
determining, based on the feature data, a prediction data set of the user set regarding the target factor;
determining, based on the prediction data set, a prediction factor that serves as the cause of the target factor from the plurality of factors; and
determining the strategy corresponding to the prediction factor as the strategy.

14. The apparatus according to claim 10, wherein obtaining the feature data comprises:
obtaining evaluation data of users in the user set for evaluating the plurality of factors; and
determining the feature data based on the evaluation data.

15. The apparatus according to claim 10, wherein obtaining the feature data comprises:
obtaining historical information about the plurality of factors of the user set within a predetermined time period; and
determining the feature data based on the historical information.

16. The apparatus according to claim 15, wherein determining the data based on the historical information comprises:
obtaining, from the historical information, a first value of one factor of the plurality of factors in a first time period and a second value in a second time period;
based on the first value and the second value, determining a data fluctuation rate of the user set regarding the one factor.

17. The apparatus according to claim 16, wherein the data fluctuation rate is a ratio of a difference between the first value and the second value to the first value or the second value.

18. The apparatus according to claim 10, wherein obtaining the condition factor from the plurality of factors based on the feature data comprises:
determining, based on the feature data, influence factors of other factors than the target factor in the plurality of factors on the target factor; and
determining a factor having an influence factor greater than a predetermined threshold among other factors as the condition factor.

19. A computer-readable storage medium having machine-executable instructions stored thereon, the machine-executable instructions, when executed by an apparatus, causing the apparatus to perform the method according to claim 1.
